(19) United States
(12) Patent Application Publication
(10) Pub. No.: US 2007/0290560 A1
(43) Pub. Date: Dec. 20, 2007

(54) Motor and Electric Apparatus Using the Same Motor

(75) Inventors: Yasuo Nanbu, Fukui (JP); Yuichiro Tashiro, Fukui (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 11/574,257

(22) PCT Filed: Jan. 28, 2005
(86) PCT No.: PCT/JP05/01630

§ 371 Date: Feb. 26, 2007

(30) Foreign Application Priority Data
Nov. 4, 2004 (JP) 2004-320216

(51) Int. Cl. H02K 5/15; H02K 5/18

(52) U.S. Cl. 310/90; 310/58; 310/89

(57) ABSTRACT

A motor includes a stator formed of an iron core wound with windings, a rotor placed opposing to the stator, a rotary shaft coupled to the rotor, a bearing holder for holding a bearing that supports the rotary shaft, and plural cooling fins placed around the bearing holder.

### TECHNICAL FIELD

The present invention relates to a motor employed in an electric apparatus such as an air conditioner, and the electric apparatus that uses the same motor. More particularly, it relates to a motor structure suitable to a fan motor in which a fan is coupled to a rotary shaft, i.e. the motor structure effectively dissipating the heat generated by the motor.

### BACKGROUND ART

A fan motor used in an air conditioner, e.g. a motor mounted at an outdoor unit, is desired to be inexpensive as well as to have a long service life. Japanese Patent Unexamined Publication No. H10-271719 discloses a conventional motor mounted at an outdoor unit of an air conditioner. This motor includes a bearing holder for holding a bearing which supports a rotary shaft, and the holder is made from insulation resin.

This motor is described here with reference to FIG. 11, which shows a sectional view illustrating a structure of the motor as prior art 1. In FIG. 11, stator iron core 530 insulated by resin is wound with stator windings 511, so that stator 510 is formed. Stator 510 is molded by insulation resin 513. In molding stator 510, a recess is prepared for holding a bearing. The recess holds bearing 5151. Rotor 520 is coupled to rotary shaft 514. Bracket 517 holds bearing 5152. The motor as prior art 1 shown in FIG. 11 is thus formed.

FIG. 12 shows a sectional view illustrating a structure of a motor as prior art 2. In FIG. 12, stator iron core 630 is wound with stator windings 611, so that stator 610 is formed. Stator 610 is molded by insulation resin 613. In molding stator 610, a recess is prepared for holding a bearing. The recess holds bearing 6151. Rotor 620 is coupled to rotary shaft 614. Bracket 617 holds bearing 6152. A hollow is formed around the place where bearing 6151 is held on insulation resin 613, so that an amount of resin 613 can be decreased. The motor as prior art 2 shown in FIG. 12 is thus formed.

FIG. 13 shows a sectional view illustrating a structure of a motor as prior art 3. In FIG. 13, stator iron core 730 is wound with stator windings 711, so that stator 710 is formed. Bracket 712 holds bearing 7151. Stator 710 is molded together with bracket 712 by insulation resin 713. Rotor 720 is coupled to rotary shaft 714. Bracket 717 holds bearing 7152. The motor as prior art 3 shown in FIG. 13 is thus formed.

FIG. 14 shows a perspective view illustrating a motor as prior art 4. In FIG. 14, bracket 812 holds a bearing (not shown). Bracket 812 is molded together with a stator (not shown) by insulation resin 813. A rotor (not shown) is coupled to rotary shaft 814. The motor as prior art 4 shown in FIG. 14 is thus formed.

The foregoing conventional motors shown as prior art 1-prior art 4 have no special structures for lowering a temperature of the bearing around the places where the bearing is held. As shown in FIG. 11 and FIG. 12, the bearing holder is formed by insulation resin, or as shown in FIG. 13 and FIG. 14, the bearing holder only is not molded by resin.

The foregoing constructions thus allow the heat generated in the stator windings to travel to the bearing, so that a temperature of the bearing becomes higher than a rated temperature of the electric apparatus in which the motor is mounted.

To overcome this problem, grease for high temperature is applied to the bearing, or a motor of higher efficiency is used in order to suppress a temperature rise of the motor. A higher efficiency is achievable by increasing a thickness of electromagnetic steel sheets laminated that form a stator iron core, or increasing an amount of copper of the stator windings by increasing the number of turns or using a winding of greater diameter.

FIG. 15 shows a relation between a bearing temperature and a service life of grease. The axis X indicates the bearing temperature, and the axis Y indicates the service life of grease. In FIG. 15, a solid line represents a regular bearing, and a broken line represents a bearing for high temperature. The bearing life depends on the service life of grease. As FIG. 15 tells, the grease life decreases, i.e. the bearing life decreases, in general, at the higher temperature of the bearing.

The bearing for high temperature can keep the grease life relatively longer than the regular bearing with respect to the bearing temperature; however, a bearing for a higher temperature often costs more expensive.

As discussed above, the measures for suppressing a temperature rise in a bearing is accompanied, in general, by a rise in cost of the bearing and a rise in material cost of the motor.

### DISCLOSURE OF INVENTION

A motor of the present invention comprises the following elements:
a stator formed of a stator iron core wound with stator windings;
a rotor facing the stator;
a rotary shaft coupled to the rotor;
a bearing holder for holding a bearing that supports the rotary shaft; and
a plurality of cooling fins disposed around the bearing holder.

This construction allows suppressing a temperature rise of the bearing because of the plural cooling fins disposed around the bearing holder. As a result, a service life of the motor can be prolonged inexpensively without using a bearing for high temperature.

An electric apparatus of the present invention comprises a motor and a housing in which the motor is mounted. The motor has the structure discussed previously. This structure allows a temperature rise in the bearing of the motor to fall within a rated temperature range of the electric apparatus in which the motor is mounted. As a result, the electric apparatus of high reliability is achievable.

### BRIEF DESCRIPTION OF DRAWINGS

FIG. 1 shows a sectional view illustrating a construction of a motor in accordance with a first exemplary embodiment of the present invention.

FIG. 2 shows a plan view of the motor shown in FIG. 1. (plan view on a cooling fin side)

FIG. 3 shows a perspective view of the motor shown in FIG. 1.

FIG. 4 shows a sectional view illustrating a construction of a motor in accordance with a second exemplary embodiment of the present invention.

FIG. 5 shows a sectional view illustrating a construction of a motor in accordance with a third exemplary embodiment of the present invention.

FIG. 6 shows a plan view of the motor shown in FIG. 5.

FIG. 7 shows a construction of an electric apparatus (outdoor unit of an air conditioner) in accordance with a fourth exemplary embodiment of the present invention.

FIG. 8 shows a construction of an electric apparatus (indoor unit of an air conditioner) in accordance with a fifth exemplary embodiment of the present invention.

FIG. 9 shows a construction of an electric apparatus (hot water supply) in accordance with a sixth exemplary embodiment of the present invention.

FIG. 10 shows a construction of an electric apparatus (air cleaner) in accordance with a seventh exemplary embodiment of the present invention.

FIG. 11 shows a sectional view illustrating a construction of a motor as prior art 1.

FIG. 12 shows a sectional view illustrating a construction of a motor as prior art 2.

FIG. 13 shows a sectional view illustrating a construction of a motor as prior art 3.

FIG. 14 shows a perspective view illustrating a construction of a motor as prior art 4.

FIG. 15 shows a relation between a temperature of a bearing and a service life of grease.

### PREFERRED EMBODIMENTS OF THE INVENTION

A motor demonstrated in the preferred embodiments comprises the following elements:
a stator formed of a stator iron core wound with stator windings;
a rotor disposed opposing to the stator;
a rotary shaft coupled to the rotor;
a bearing holder for holding a bearing that supports the rotary shaft; and
a plurality of cooling fins disposed around the bearing holder.

The electric apparatus of the present invention comprises a motor and a housing in which the motor is mounted, and this motor comprises the following elements:
a stator formed of a stator iron core wound with stator windings;
a rotor disposed opposing to the stator;
a rotary shaft coupled to the rotor;
a bearing holder for holding a bearing that supports the rotary shaft; and
a plurality of cooling fins disposed around the bearing holder.

Exemplary embodiments of the present invention are demonstrated hereinafter with reference to the accompanying drawings.

### Exemplary Embodiment 1

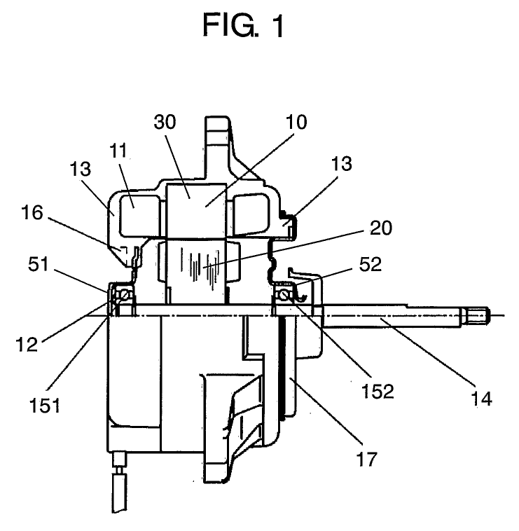

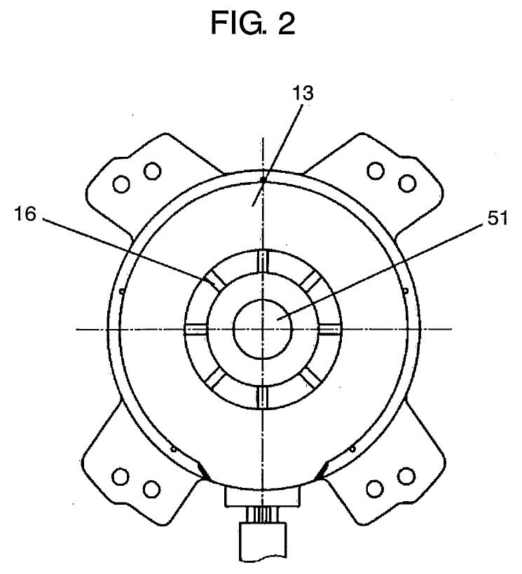

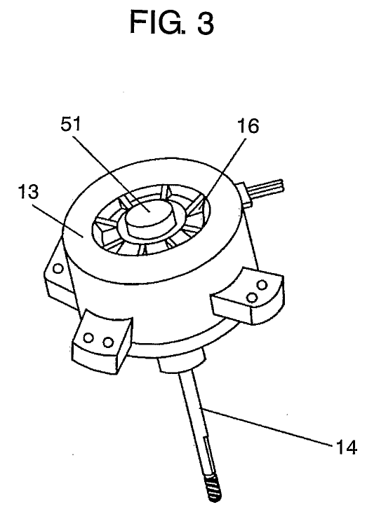

FIG. 1 shows a sectional view illustrating a construction of a motor in accordance with the first exemplary embodiment of the present invention. FIG. 2 shows a plan view of the motor shown in FIG. 1, and FIG. 3 shows a perspective view of the motor shown in FIG. 1.

In FIG. 1, stator iron core 30 insulated by resin is wound with stator windings 11, so that stator 10 is formed. Stator 10, first bracket 12 and plural cooling fins 16 are molded into one unit by insulation resin 13, thereby forming a complete stator. Material of insulation resin 13 is desirably thermosetting resin (unsaturated polyester resin). Rotor 20 is disposed inside stator 10 via space in between and faces stator 10. Rotor 20 is coupled to rotary shaft 14, which is equipped with first bearing 151 and second bearing 152, thereby forming a complete rotor.

First bearing holder 51 is formed at first bracket 12, and holder 51 holds bearing 151. Second bearing holder 52 is formed at second bracket 17, and holder 52 holds bearing 152. Rotary shaft 14 is rotatably supported by bearings 151 and 152.

The foregoing complete rotor is combined to the foregoing complete stator, and bracket 17 is engaged with both of the rotor and the stator, thereby completing the assembly of the motor.

Cooling fin 16 is detailed hereinafter. As shown in FIGS. 2 and 3, eight pieces of cooling fins 16 are equidistantly disposed at intervals of 45 degrees around bearing holder 51 formed at bracket 12 such that fins 16 surround bearing holder 51. The number of cooling fins is not limited to eight pieces, but the number of pieces is determined appropriately to a situation such as easiness of molding, necessity of heat dissipation.

In the motor in accordance with the first embodiment, comparison of bearing 151 with bearing 152 tells that a temperature of bearing 151 tends to be higher than a temperature of bearing 152. The reason is that rotary shaft 14 extends outside the motor through bearing 152, so that the heat generated from rotor 20 can be discharged with ease. The total area of bracket 17 is greater than the total area of bracket 12, so that the heat generated from the motor can be dissipated with ease.

For instance, in a motor, comparison of a temperature of bearing 151 with a temperature of bearing 152 finds that bearing 151 has higher temperature than bearing 152 by 10-15° C.

The presence of cooling fins 16 surrounding bearing holder 51 proves that the temperature lowers by 5° C. or more than 5° C.

### Exemplary Embodiment 2

The foregoing embodiment 1 shows an instance of forming a bearing holder at a part of a bracket of a motor; however, a bearing holder can be formed from resin without using a bracket, and plural cooling fins can be provided around the bearing holder. In such a case, when a stator of which iron core is wound with windings is formed from insulation resin, the bearing holder can be simultaneously integrated with the stator by the insulation resin.

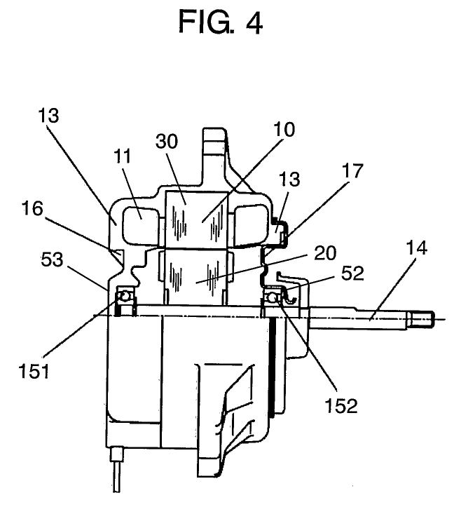

This construction is detailed as the second embodiment with reference to FIG. 4, which shows a sectional view illustrating a structure of the motor. In FIG. 4, stator iron core 30 insulated by resin is wound with windings 11, thereby forming stator 10. Stator 10 and plural cooling fins 16 are molded into one body by insulation resin 13, thereby forming a complete stator. When the stator is molded by insulation resin 13, first bearing holder 53 is also molded by the insulation resin simultaneously. The material of resin 13 is preferably thermosetting resin (unsaturated polyester resin).

Rotor 20 is disposed inside stator 10 via space in between and faces stator 10. Rotor 20 is coupled to rotary shaft 14, which is equipped with first bearing 151 and second bearing 152, thereby forming a complete rotor.

Bearing holder 53 made from insulation resin 13 holds bearing 151. Second bearing holder 52 is formed at bracket 17, and holds bearing 152. Rotary shaft 14 is rotatably supported by bearings 151 and 152.

The foregoing complete rotor is combined to the foregoing complete stator, and bracket 17 is engaged with both of the rotor and the stator, thereby completing the assembly of the motor.

This second embodiment differs from the first one shown in FIG. 1 in the following point: The second embodiment does not use bracket 12 shown in FIG. 1, but bearing holder 53 is formed by insulation resin 13, while the stator is molded by this resin 13.

In this second embodiment, eight pieces of cooling fins 16 are equidistantly provided at intervals of 45 degrees such that they surround bearing holder 53. The number of cooling fins is not limited to eight pieces, but the number of pieces is determined appropriately to a situation such as easiness of molding, necessity of heat dissipation. The construction discussed above produces a similar advantage what is discussed in the first embodiment.

### Exemplary Embodiment 3

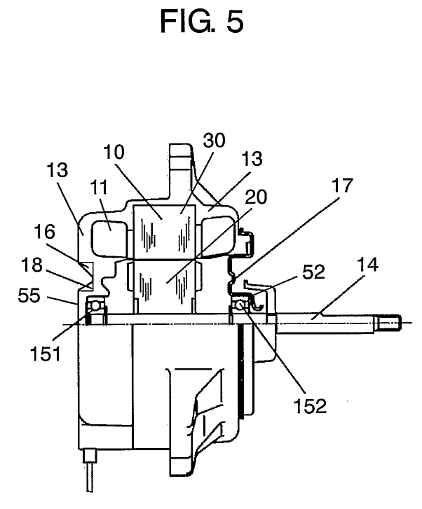

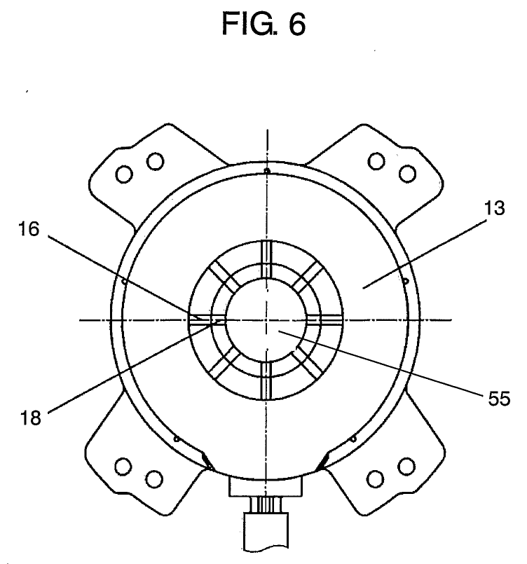

FIG. 5 shows a sectional view illustrating a construction of a motor in accordance with the third exemplary embodiment of the present invention. FIG. 6 shows a plan view of the motor shown in FIG. 5. In FIGS. 5 and 6, stator iron core 30 insulated by resin is wound with windings 11, thereby forming stator 10. Stator 10, plural first cooling fins 16 and plural second cooling fins 18 are molded into one body by insulation resin 13, thereby completing a stator. When the stator is molded by insulation resin 13, first bearing holder 55 is also molded by the insulation resin simultaneously. The material of resin 13 is preferably thermosetting resin (unsaturated polyester resin).

Rotor 20 is disposed inside stator 10 via space in between and faces stator 10. Rotor 20 is coupled to rotary shaft 14, which is equipped with first bearing 151 and second bearing 152, thereby forming a complete rotor.

Bearing holder 55 made from insulation resin 13 holds bearing 151. Second bearing holder 52 is formed at bracket 17, and holds bearing 152. Rotary shaft 14 is rotatably supported by bearings 151 and 152.

The foregoing complete rotor is combined to the foregoing complete stator, and bracket 17 is engaged with both of the rotor and the stator, thereby completing the assembly of the motor.

This third embodiment differs from the second one in the structure of the cooling fins. In the second embodiment shown in FIG. 4, eight pieces of cooling fins 16 are disposed equidistantly at intervals of 45 degrees around bearing holder 53 such that they surround bearing holder 53.

On the other hand, in the third embodiment shown in FIG. 5, not only cooling fins 16 but also cooling fins 18 are disposed around and closer to bearing holder 55. Eight pieces of fins 18 surround bearing holder 55 equidistantly from each other at intervals of 45 degrees as cooling fins 16 do.

The number of cooling fins 16 and 18 is not limited to eight pieces respectively, but the number of pieces is determined appropriately to a situation such as easiness of molding, necessity of heat dissipation.

The construction according to the third embodiment is expected to produce heat dissipation effect greater than that of the second embodiment.

### Exemplary Embodiment 4

An electric apparatus of the present invention comprises a motor and a housing in which the motor is mounted, and the apparatus employs the motor of the present invention.

An outdoor unit of an air conditioner is detailed as the fourth exemplary embodiment of the present invention, and the outdoor unit is taken as an example of the electric apparatus of the present invention.

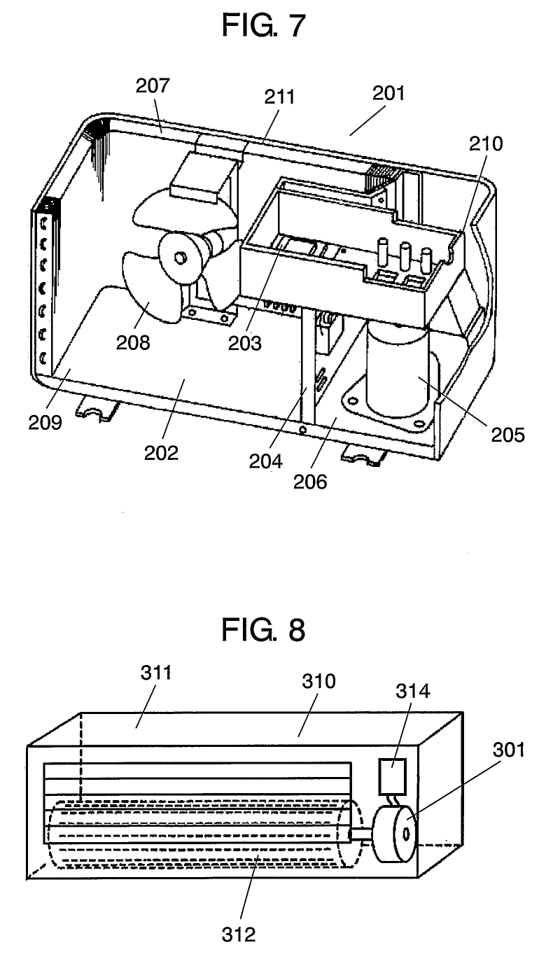

In FIG. 7, outdoor unit 201 includes motor 208 in housing 211, and motor 208 has a fan on its rotary shaft, so that motor 208 works as a fan motor for blowing.

Outdoor unit 201 is separated into compressing chamber 206 and heat exchanging chamber 209 by partition plate 204 standing on bottom plate 202 of housing 211. Compressor 205 is disposed in compressing chamber 206, and heat exchanger 207 as well as fan motor 208 is disposed in heat exchanging chamber 209. Accessory box 210 is placed on partition plate 204.

Motor 208 is driven by motor driver 203 accommodated in accessory box 210. Rotation of motor 208 spins the blowing fan, so that heat exchanging chamber 209 is cooled by the wind from the fan. Motor 208 can employ the motor demonstrated in embodiment 1, 2 or 3.

The foregoing construction allows a temperature rise in the bearing of the motor mounted in the outdoor unit of an air conditioner to fall within a rated temperature range of the apparatus, i.e. the outdoor unit, so that the reliable electric apparatus can be expected.

### Exemplary Embodiment 5

An indoor unit as an example of the electric apparatus of the present invention is detailed hereinafter as the fifth exemplary embodiment.

In FIG. 8, indoor unit 310 comprises housing 311 and motor 301 disposed in housing 311. Motor 301 includes cross-flow fan 312 on its rotary shaft. Motor 301 is driven by motor driver 314, which powers motor 301 to rotate, and cross-flow fan 312 spins. Rotation of fan 312 blows wind conditioned by a heat exchanger (not shown) of the indoor unit into a room. Motor 301 can employ the motor demonstrated in embodiment 1, 2 or 3.

The construction discussed above allows a temperature rise of the bearing of the motor disposed in the indoor unit to fall within a rated temperature range of the indoor unit, i.e. an electric apparatus, so that an electric apparatus of high reliability is obtainable.

### Exemplary Embodiment 6

A construction of a hot water supply is detailed as an example of an electric apparatus of the present invention in this sixth embodiment.

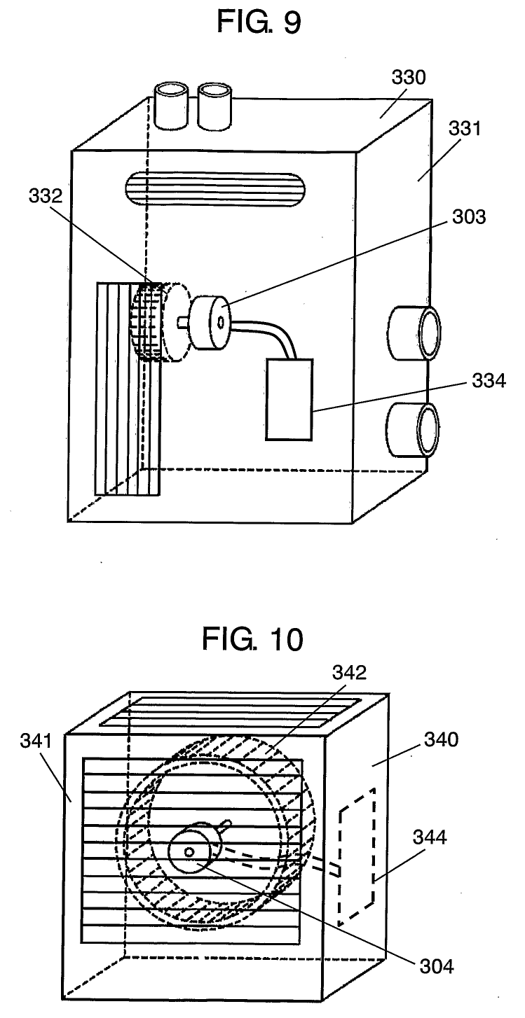

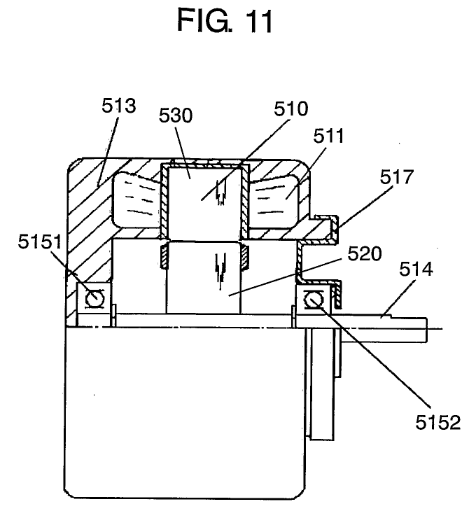

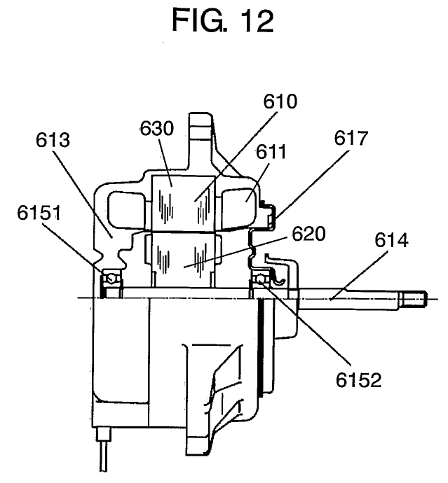

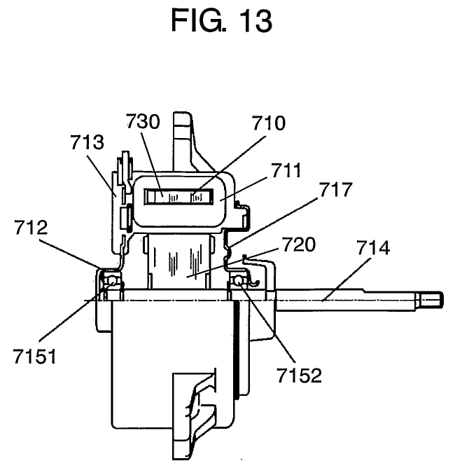

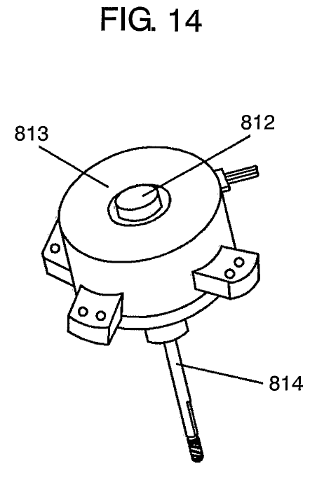

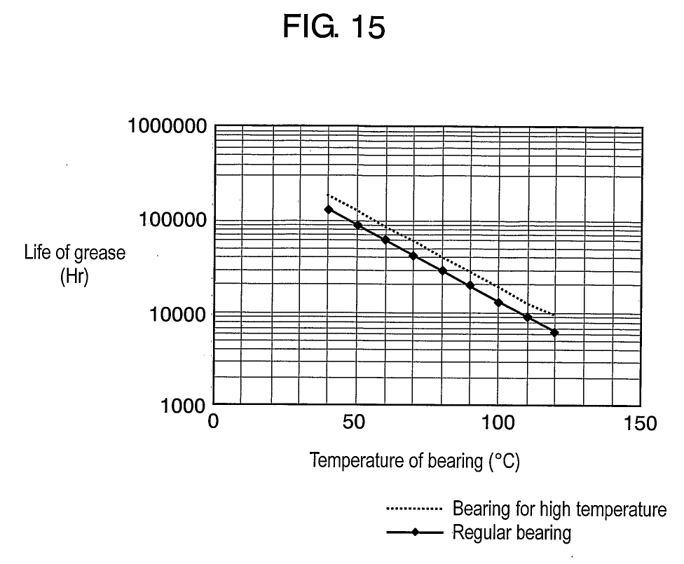

In FIG. 9, hot water supply 330 comprises housing 331 and motor 303 disposed in housing 331. Motor 303 includes fan 332 on its rotary shaft. Motor 303 is driven by motor driver 334, which powers motor 303 to rotate, and fan 332 spins. Rotation of fan 332 flows air necessary for burning into a fuel vaporizing chamber (not shown). Motor 303 can employ the motor demonstrated in embodiment 1, 2 or 3.

The construction discussed above allows a temperature rise in the bearing of the motor disposed in the hot water supply to fall within a rated temperature range of the hot water supply, i.e. an electric apparatus, so that a reliable electric apparatus is achievable.

### Exemplary Embodiment 7

A construction of an air cleaner is detailed as an example of an electric apparatus of the present invention in this seventh embodiment.

In FIG. 10, air cleaner 340 comprises housing 341 and motor 304 disposed in housing 341. Motor 304 has air-circulating fan 342 on its rotary shaft. Motor 304 is driven by motor driver 344, which powers motor 304 to rotate, and fan 342 spins. Rotation of fan 342 circulates air. Motor 304 can employ the motor demonstrated in embodiment 1, 2 or 3.

This construction allows a temperature rise of the bearing holder of the motor disposed in the air cleaner to fall within a rated temperature range of the air cleaner, i.e. an electric apparatus, so that a reliable electric apparatus is obtainable.

In the foregoing descriptions, an outdoor unit and an indoor unit of an air conditioner, a hot water supply, and an air cleaner are taken as examples of electric apparatuses, and fan motors disposed in those apparatuses are demonstrated. The motor of the present invention, not to mention, can be used in a variety of information apparatuses and industrial apparatuses.

### INDUSTRIAL APPLICABILITY

The motor of the present invention is suited for a fan motor employed in an electric apparatus, which needs an inexpensive motor of a longer life, such as an outdoor unit and an indoor unit of an air conditioner, a hot water supply, and an air cleaner.

1. A motor comprising:
a stator of which iron core is wound with windings;
a rotor disposed opposing to the stator;
a rotary shaft coupled to the rotor;
a bearing holder for holding a bearing that supports the rotary shaft; and
a plurality of cooling fins disposed around the bearing holder.

2. The motor of claim 1, wherein the bearing holder is made from resin.

3. The motor of claim 1, wherein the stator and the bearing holder are formed into one body by insulation resin.

4. The motor of claim 1 further comprising a bracket, at which the bearing holder is formed.

5. The motor of claim 1 further comprising a bracket, at which the bearing holder is formed, and the stator and the bracket are formed into one body by insulation resin.

6. An electric apparatus comprising:
a motor; and
a housing in which the motor is mounted, wherein the motor includes:
a stator of which iron core is wound with windings;
a rotor disposed opposing to the stator;
a rotary shaft coupled to the rotor;
a bearing holder for holding a bearing that supports the rotary shaft; and
a plurality of cooling fins disposed around the bearing holder.

7. The electric apparatus of claim 6, wherein the bearing holder is made from resin.

8. The electric apparatus of claim 6, wherein the stator and the bearing holder are formed into one body by insulation resin.

9. The electric apparatus of claim 6 further comprising a bracket, at which the bearing holder is formed.

10. The electric apparatus of claim 6 further comprising a bracket, at which the bearing holder is formed, and the stator and the bracket are formed into one body by insulation resin.
